(19) United States
(12) Patent Application Publication
(10) Pub. No.: US 2025/0142315 A1
(43) Pub. Date: May 1, 2025

(54) PROXY TRANSMISSION IN WIRELESS NETWORKS

(71) Applicant: Samsung Electronics Co., Ltd., Suwon-si (KR)

(72) Inventors: Matthew Tonnemacher, Allen, TX (US); Bilal Sadiq, Plano, TX (US)

(21) Appl. No.: 18/916,534

(22) Filed: Oct. 15, 2024

Related U.S. Application Data
(60) Provisional application No. 63/546,821, filed on Nov. 1, 2023.

(51) Int. Cl. H04W 8/00; H04L 67/51; H04W 84/12

(52) U.S. Cl. CPC H04W 8/005; H04L 67/51; H04W 84/12

(57) ABSTRACT

An embodiment includes a station (STA) in a wireless network, the STA comprising a memory and a processor coupled to the memory, the processor configured to receive, from an origin STA, a first discovery frame that includes one or more services intended for proxy transmission and one or more service identifiers each associated with a respective one of the one or more services, identify the one or more services based on the one or more service identifiers, generate a second discovery frame based on the first discovery frame, wherein the second discovery frame includes the one or more services intended for proxy transmission included in the first discovery frame; and transmit, to one or more other STAs on behalf of the origin STA, the second discovery frame.

### CROSS-REFERENCE TO RELATED APPLICATION(S)

This application claims the benefit of priority from U.S. Provisional Application No. 63/546,821, entitled “Origin Device Service Discovery Frame (SDF) Triggering A Proxy Device's Derivative Transmission” filed Nov. 1, 2023, which is incorporated herein by reference in its entirety.

### TECHNICAL FIELD

This disclosure relates generally to a wireless communication system, and more particularly to, for example, but not limited to, proxy transmission in wireless networks.

### BACKGROUND

Wireless local area network (WLAN) technology has evolved toward increasing data rates and continues its growth in various markets such as home, enterprise and hotspots over the years since the late 1990s. WLAN allows devices to access the internet in the 2.4 GHz, 5 GHZ, 6 GHz or 60 GHz frequency bands. WLANs are based on the Institute of Electrical and Electronic Engineers (IEEE) 802.11 standards. IEEE 802.11 family of standards aims to increase speed and reliability and to extend the operating range of wireless networks.

WLAN devices are increasingly required to support a variety of delay-sensitive applications or real-time applications such as augmented reality (AR), robotics, artificial intelligence (AI), cloud computing, and unmanned vehicles. To implement extremely low latency and extremely high throughput required by such applications, multi-link operation (MLO) has been suggested for the WLAN. The WLAN is formed within a limited area such as a home, school, apartment, or office building by WLAN devices. Each WLAN device may have one or more stations (STAs) such as the access point (AP) STA and the non-access-point (non-AP) STA.

Wi-Fi Aware, also known as Neighbor Awareness Networking (NAN), is a specification put forward by the Wi-Fi Alliance that focuses on ad-hoc peer to peer (P2P) networking. The specification allows devices to connect with each other to fulfill specific service-based needs. A feature of this specification is Discovery. NAN Discovery may be handled by a NAN Discovery Engine, and can include publishing services advertisements for devices in a NAN network. NAN service advertisements are typically transmitted multiple times (e.g., periodically) by a device in a NAN cluster. A device offering/requesting a service may do the service advertisement. Many devices have limited power, so frequently transmitting advertisements can be a costly activity.

There are numerous ways to publish services advertisements. For example, a NAN device can initiate periodic publish messages to solicit a subscription to the service(s). Conversely, a NAN device can instead initiate by repeatedly (e.g., periodically) sending subscribe messages to search for another device offering specific services. In either case, to increase the likelihood of finding a matching publisher/subscriber, these messages may need to be sent repeatedly for an extended time.

The description set forth in the background section should not be assumed to be prior art merely because it is set forth in the background section. The background section may describe aspects or embodiments of the present disclosure.

### SUMMARY

One aspect of the present disclosure provides a station (STA) in a wireless network, the STA comprising a memory and a processor coupled to the memory. The processor is configured to receive, from an origin STA, a first discovery frame that includes one or more services intended for proxy transmission and one or more service identifiers each associated with a respective one of the one or more services. The processor is configured to identify the one or more services based on the one or more service identifiers. The processor is configured to generate a second discovery frame based on the first discovery frame, wherein the second discovery frame includes the one or more services intended for proxy transmission included in the first discovery frame. The processor is configured to transmit, to one or more other STAs on behalf of the origin STA, the second discovery frame.

In some embodiments, the one or more services include a publish service that is a service that the origin STA offers to the one or more other STAs or a subscribe service that is a service that the origin STA seeks from the one or more other STAs.

In some embodiments, the first discovery frame solicits that the STA transmits the second discovery frame.

In some embodiments, the processor is further configured to receive a trigger frame soliciting that the STA transmits the second discovery frame, and transmit, to the one or more other STAs, the second discovery frame in response to the trigger frame.

In some embodiments, the processor is further configured to transmit the second discovery frame after a time offset after receiving the first discovery frame from the origin STA.

In some embodiments, the processor is further configured to receive, from the origin STA, a third discovery frame that includes updated one or more services intended for proxy transmission and updated one or more service identifiers each associated with a respective one of the one or more services, generate a fourth discovery frame based on the third discovery frame, wherein the fourth discovery frame includes the updated one or more services intended for proxy transmission included in the third discovery frame, and transmit, to the one or more other STAs, the fourth discovery frame.

In some embodiments, the first discovery frame is received during a discovery window.

In some embodiments, the first discovery frame is received in a first frequency band and the second discovery frame is transmitted on a second frequency band.

One aspect of the present disclosure provides a station (STA) in a wireless network, the STA comprising a memory and a processor coupled to the memory. The processor is configured to transmit, to a proxy STA, a first discovery frame that includes the one or more services intended for proxy transmission and one or more service identifiers each associated with a respective one of the one or more services. The processor is configured to listen for a transmission to one or more other STAs of a second discovery frame derived from the first discovery frame during one or more expected discovery windows during which the proxy STA is expected to perform proxied transmission of the second discovery frame.

In some embodiments, processor is further configured to determine that the proxy STA is not transmitting the second discovery frame for a predetermined time, and retransmit the first discovery frame to the proxy STA.

In some embodiments, the processor is further configure to transmit, to the proxy STA, a trigger frame that solicits that the proxy STA transmits the second discovery frame.

In some embodiments, the first discovery frame is transmitted during a discovery window.

In some embodiments, the first discovery frame is transmitted in a first frequency band and the second discovery frame is transmitted on a second frequency band.

### BRIEF DESCRIPTION OF THE DRAWINGS

FIG. 1 illustrates an example of a wireless network in accordance with an embodiment.

FIG. 2A illustrates an example of AP in accordance with an embodiment.

FIG. 2B illustrates an example of STA in accordance with an embodiment.

FIG. 3 illustrates an example of multi-link communication operation in accordance with an embodiment.

FIG. 4 illustrates an architecture of a Neighbor Awareness Networking (NAN) engine in accordance with an embodiment.

FIG. 5 illustrates an operation between two devices engaging in discovery through a proxy device in accordance with an embodiment.

FIG. 6 illustrates communication between an origin device and a proxy device for proxy transmission in accordance with an embodiment.

FIG. 7 illustrates a block diagram example depicting an origin device triggering a proxy device's discovery frame transmission in accordance with an embodiment.

FIG. 8 illustrates an example depicting an origin device verifying proxy operation by listening for discovery frame transmissions in accordance with an embodiment.

FIG. 9 communication between an origin device and a proxy device for proxy transmission based on a trigger frame in accordance with an embodiment.

FIG. 10 illustrates an example depicting an origin device transmitting a discovery frame to be sent via proxy followed by a triggering message to trigger proxy transmission in accordance with an embodiment.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in various ways, all without departing from the scope of the present disclosure. Accordingly, the drawings and description are to be regarded as illustrative in nature and not restrictive. Like reference numerals designate like elements.

The following description is directed to certain implementations for the purpose of describing the innovative aspects of this disclosure. However, a person having ordinary skill in the art will readily recognize that the teachings herein can be applied in a multitude of different ways. The examples in this disclosure are based on WLAN communication according to the Institute of Electrical and Electronics Engineers (IEEE) 802.11 standard, including IEEE 802.11be standard and any future amendments to the IEEE 802.11 standard. However, the described embodiments may be implemented in any device, system or network that is capable of transmitting and receiving radio frequency (RF) signals according to the IEEE 802.11 standard, the Bluetooth standard, Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), 5G NR (New Radio), AMPS, or other known signals that are used to communicate within a wireless, cellular or internet of things (IoT) network, such as a system utilizing 3G, 4G, 5G, 6G, or further implementations thereof, technology.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Multi-link operation (MLO) is a key feature that is currently being developed by the standards body for next generation extremely high throughput (EHT) Wi-Fi systems in IEEE 802.11be. The Wi-Fi devices that support MLO are referred to as multi-link devices (MLD). With MLO, it is possible for a non-AP MLD to discover, authenticate, associate, and set up multiple links with an AP MLD. Channel access and frame exchange is possible on each link between the AP MLD and non-AP MLD.

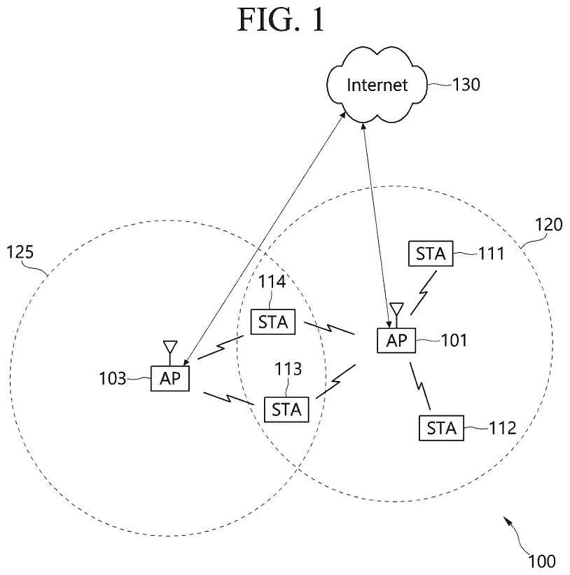

FIG. 1 shows an example of a wireless network 100 in accordance with an embodiment. The embodiment of the wireless network 100 shown in FIG. 1 is for illustrative purposes only. Other embodiments of the wireless network 100 could be used without departing from the scope of this disclosure.

As shown in FIG. 1, the wireless network 100 may include a plurality of wireless communication devices. Each wireless communication device may include one or more stations (STAs). The STA may be a logical entity that is a singly addressable instance of a medium access control (MAC) layer and a physical (PHY) layer interface to the wireless medium. The STA may be classified into an access point (AP) STA and a non-access point (non-AP) STA. The AP STA may be an entity that provides access to the distribution system service via the wireless medium for associated STAs. The non-AP STA may be a STA that is not contained within an AP-STA. For the sake of simplicity of description, an AP STA may be referred to as an AP and a non-AP STA may be referred to as a STA. In the example of FIG. 1, APs 101 and 103 are wireless communication devices, each of which may include one or more AP STAs. In such embodiments, APs 101 and 103 may be AP multi-link device (MLD). Similarly, STAs 111-114 are wireless communication devices, each of which may include one or more non-AP STAs. In such embodiments, STAs 111-114 may be non-AP MLD.

The APs 101 and 103 communicate with at least one network 130, such as the Internet, a proprietary Internet Protocol (IP) network, or other data network. The AP 101 provides wireless access to the network 130 for a plurality of stations (STAs) 111-114 with a coverage are 120 of the AP 101. The APs 101 and 103 may communicate with each other and with the STAs using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

In FIG. 1, dotted lines show the approximate extents of the coverage area 120 and 125 of APs 101 and 103, which are shown as approximately circular for the purposes of illustration and explanation. It should be clearly understood that coverage areas associated with APs, such as the coverage areas 120 and 125, may have other shapes, including irregular shapes, depending on the configuration of the APs.

As described in more detail below, one or more of the APs may include circuitry and/or programming for management of MU-MIMO and OFDMA channel sounding in WLANs. Although FIG. 1 shows one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101 and 103 could communicate directly with the network 130 and provides STAs with direct wireless broadband access to the network 130. Further, the APs 101 and/or 103 could provide access to other or additional external networks, such as external telephone networks or other types of data networks.

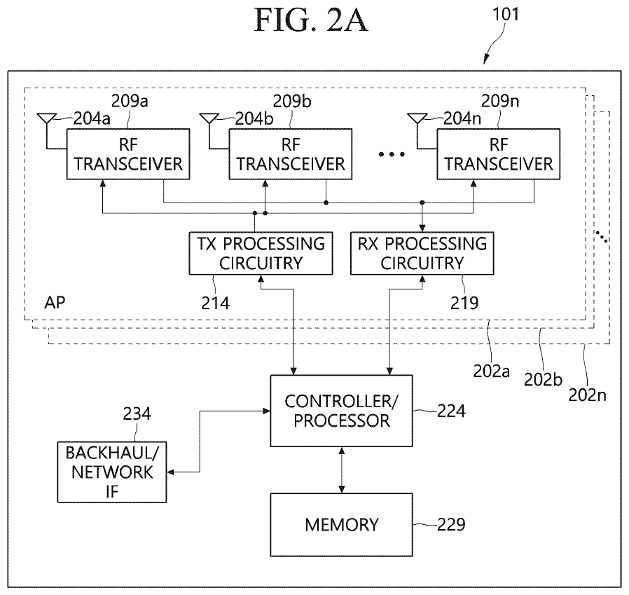

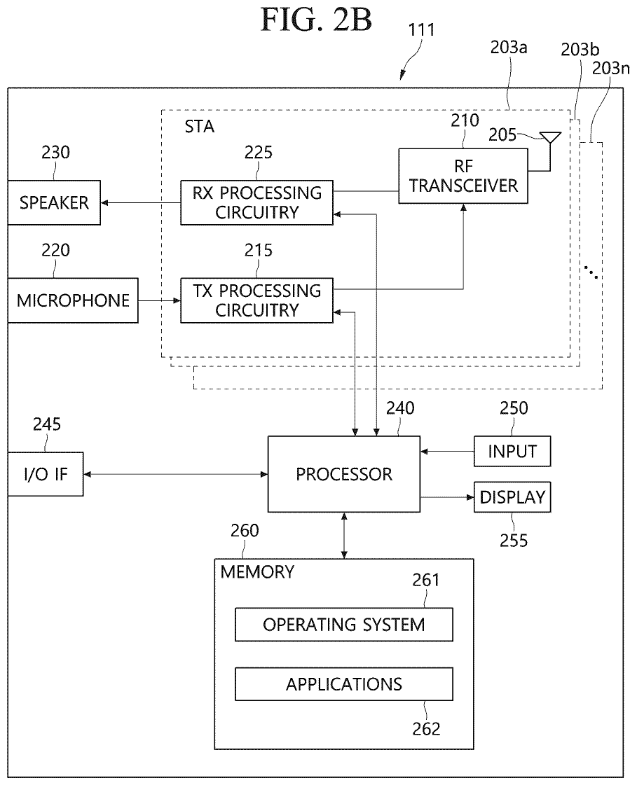

FIG. 2A shows an example of AP 101 in accordance with an embodiment. The embodiment of the AP 101 shown in FIG. 2A is for illustrative purposes, and the AP 103 of FIG. 1 could have the same or similar configuration. However, APs come in a wide range of configurations, and FIG. 2A does not limit the scope of this disclosure to any particular implementation of an AP.

As shown in FIG. 2A, the AP 101 may include multiple antennas 204a-204n, multiple radio frequency (RF) transceivers 209a-209n, transmit (TX) processing circuitry 214, and receive (RX) processing circuitry 219. The AP 101 also may include a controller/processor 224, a memory 229, and a backhaul or network interface 234. The RF transceivers 209a-209n receive, from the antennas 204a-204n, incoming RF signals, such as signals transmitted by STAs in the network 100. The RF transceivers 209a-209n down-convert the incoming RF signals to generate intermediate (IF) or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

The TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of uplink signals and the transmission of downlink signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including a combination of DL MU-MIMO and OFDMA in the same transmit opportunity. In some embodiments, the controller/processor 224 may include at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 may include any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for management of channel sounding procedures in WLANs. Although FIG. 2A illustrates one example of AP 101, various changes may be made to FIG. 2A. For example, the AP 101 could include any number of each component shown in FIG. 2A. As a particular example, an AP could include a number of interfaces 234, and the controller/processor 224 could support routing functions to route data between different network addresses. As another example, while shown as including a single instance of TX processing circuitry 214 and a single instance of RX processing circuitry 219, the AP 101 could include multiple instances of each (such as one per RF transceiver). Alternatively, only one antenna and RF transceiver path may be included, such as in legacy APs. Also, various components in FIG. 2A could be combined, further subdivided, or omitted and additional components could be added according to particular needs.

As shown in FIG. 2A, in some embodiment, the AP 101 may be an AP MLD that includes multiple APs 202a-202n. Each AP 202a-202n is affiliated with the AP MLD 101 and includes multiple antennas 204a-204n, multiple radio frequency (RF) transceivers 209a-209n, transmit (TX) processing circuitry 214, and receive (RX) processing circuitry 219. Each APs 202a-202n may independently communicate with the controller/processor 224 and other components of the AP MLD 101. FIG. 2A shows that each AP 202a-202n has separate multiple antennas, but each AP 202a-202n can share multiple antennas 204a-204n without needing separate multiple antennas. Each AP 202a-202n may represent a physical (PHY) layer and a lower media access control (MAC) layer.

FIG. 2B shows an example of STA 111 in accordance with an embodiment. The embodiment of the STA 111 shown in FIG. 2B is for illustrative purposes, and the STAs 111-114 of FIG. 1 could have the same or similar configuration. However, STAs come in a wide variety of configurations, and FIG. 2B does not limit the scope of this disclosure to any particular implementation of a STA.

As shown in FIG. 2B, the STA 111 may include antenna(s) 205, a RF transceiver 210, TX processing circuitry 215, a microphone 220, and RX processing circuitry 225. The STA 111 also may include a speaker 230, a controller/processor 240, an input/output (I/O) interface (IF) 245, a touchscreen 250, a display 255, and a memory 260. The memory 260 may include an operating system (OS) 261 and one or more applications 262.

The RF transceiver 210 receives, from the antenna(s) 205, an incoming RF signal transmitted by an AP of the network 100. The RF transceiver 210 down-converts the incoming RF signal to generate an IF or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

The TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205.

The controller/processor 240 can include one or more processors and execute the basic OS program 261 stored in the memory 260 in order to control the overall operation of the STA 111. In one such operation, the controller/processor 240 controls the reception of downlink signals and the transmission of uplink signals by the RF transceiver 210, the RX processing circuitry 225, and the TX processing circuitry 215 in accordance with well-known principles. The controller/processor 240 can also include processing circuitry configured to provide management of channel sounding procedures in WLANs. In some embodiments, the controller/processor 240 may include at least one microprocessor or microcontroller.

The controller/processor 240 is also capable of executing other processes and programs resident in the memory 260, such as operations for management of channel sounding procedures in WLANs. The controller/processor 240 can move data into or out of the memory 260 as required by an executing process. In some embodiments, the controller/processor 240 is configured to execute a plurality of applications 262, such as applications for channel sounding, including feedback computation based on a received null data packet announcement (NDPA) and null data packet (NDP) and transmitting the beamforming feedback report in response to a trigger frame (TF). The controller/processor 240 can operate the plurality of applications 262 based on the OS program 261 or in response to a signal received from an AP. The controller/processor 240 is also coupled to the I/O interface 245, which provides STA 111 with the ability to connect to other devices such as laptop computers and handheld computers. The I/O interface 245 is the communication path between these accessories and the main controller/processor 240.

The controller/processor 240 is also coupled to the input 250 (such as touchscreen) and the display 255. The operator of the STA 111 can use the input 250 to enter data into the STA 111. The display 255 may be a liquid crystal display, light emitting diode display, or other display capable of rendering text and/or at least limited graphics, such as from web sites. The memory 260 is coupled to the controller/processor 240. Part of the memory 260 could include a random access memory (RAM), and another part of the memory 260 could include a Flash memory or other read-only memory (ROM).

Although FIG. 2B shows one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the controller/processor 240 could be divided into multiple processors, such as one or more central processing units (CPUs) and one or more graphics processing units (GPUs). Also, while FIG. 2B illustrates the STA 111 configured as a mobile telephone or smartphone, STAs could be configured to operate as other types of mobile or stationary devices.

As shown in FIG. 2B, in some embodiment, the STA 111 may be a non-AP MLD that includes multiple STAs 203a-203n. Each STA 203a-203n is affiliated with the non-AP MLD 111 and includes an antenna(s) 205, a RF transceiver 210, TX processing circuitry 215, and RX processing circuitry 225. Each STAs 203a-203n may independently communicate with the controller/processor 240 and other components of the non-AP MLD 111. FIG. 2B shows that each STA 203a-203n has a separate antenna, but each STA 203a-203n can share the antenna 205 without needing separate antennas. Each STA 203a-203n may represent a physical (PHY) layer and a lower media access control (MAC) layer.

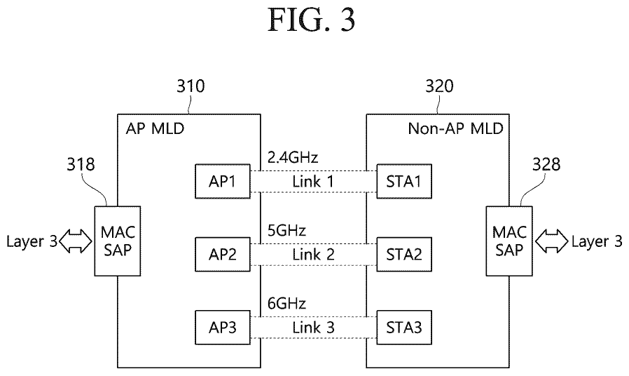

FIG. 3 shows an example of multi-link communication operation in accordance with an embodiment. The multi-link communication operation may be usable in IEEE 802.11be standard and any future amendments to IEEE 802.11 standard. In FIG. 3, an AP MLD 310 may be the wireless communication device 101 and 103 in FIG. 1 and a non-AP MLD 220 may be one of the wireless communication devices 111-114 in FIG. 1.

As shown in FIG. 3, the AP MLD 310 may include a plurality of affiliated APs, for example, including AP 1, AP 2, and AP 3. Each affiliated AP may include a PHY interface to wireless medium (Link 1, Link 2, or Link 3). The AP MLD 310 may include a single MAC service access point (SAP) 318 through which the affiliated APs of the AP MLD 310 communicate with a higher layer (Layer 3 or network layer). Each affiliated AP of the AP MLD 310 may have a MAC address (lower MAC address) different from any other affiliated APs of the AP MLD 310. The AP MLD 310 may have a MLD MAC address (upper MAC address) and the affiliated APs share the single MAC SAP 318 to Layer 3. Thus, the affiliated APs share a single IP address, and Layer 3 recognizes the AP MLD 310 by assigning the single IP address.

The non-AP MLD 320 may include a plurality of affiliated STAs, for example, including STA 1, STA 2, and STA 3. Each affiliated STA may include a PHY interface to the wireless medium (Link 1, Link 2, or Link 3). The non-AP MLD 320 may include a single MAC SAP 328 through which the affiliated STAs of the non-AP MLD 320 communicate with a higher layer (Layer 3 or network layer). Each affiliated STA of the non-AP MLD 320 may have a MAC address (lower MAC address) different from any other affiliated STAs of the non-AP MLD 320. The non-AP MLD 320 may have a MLD MAC address (upper MAC address) and the affiliated STAs share the single MAC SAP 328 to Layer 3. Thus, the affiliated STAs share a single IP address, and Layer 3 recognizes the non-AP MLD 320 by assigning the single IP address.

The AP MLD 310 and the non-AP MLD 320 may set up multiple links between their affiliate APs and STAs. In this example, the AP 1 and the STA 1 may set up Link 1 which operates in 2.4 GHz band. Similarly, the AP 2 and the STA 2 may set up Link 2 which operates in 5 GHZ band, and the AP 3 and the STA 3 may set up Link 3 which operates in 6 GHz band. Each link may enable channel access and frame exchange between the AP MLD 310 and the non-AP MLD 320 independently, which may increase date throughput and reduce latency. Upon associating with an AP MLD on a set of links (setup links), each non-AP device is assigned a unique association identifier (AID).

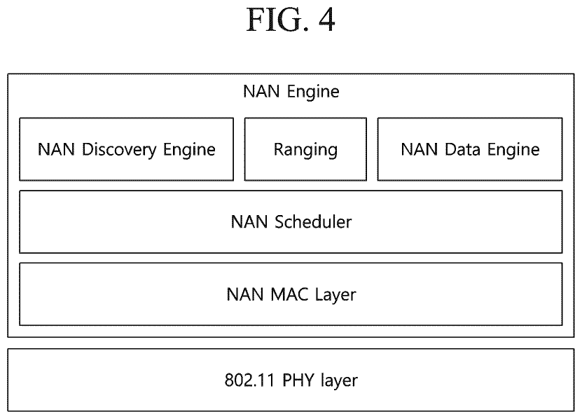

FIG. 4 illustrates an architecture of a NAN engine in accordance with an embodiment. The NAN engine may include a NAN discovery engine module, a Ranging module, a NAN Data Engine module, a NAN Scheduler module, a NAN Medium Access Control (Mac) layer module, and an 802.11 PHY Layer module.

The NAN discovery engine may be responsible for discovering devices and/or services made available on devices for specific services through Publish and Subscribe messages. Publish messages may advertise a service(s) offered by a NAN device and subscribe messages may advertise a willingness to engage with a device that offers a service(s).

The Ranging module may estimate the distance between NAN Devices that support the ranging capability. Ranging may be used in addition to the service discovery mechanism to estimate the distance to a NAN device providing a specific service. The NAN Data Engine module may provide the NAN Data Link (NDL) capability that may be used to setup a data link between NAN Devices. The NAN Scheduler module may establish, maintain, and terminate Wi-Fi radio resource schedules for NAN operations. The NAN Scheduler module may also be responsible for coordinating concurrent NAN and Non-NAN operations. The NAN MAC layer module may process and handle the NAN Beacon frames and NAN Service Discovery frames. The 802.11 PHY Layer module may provide data transport services to higher layers.

As described, NAN Discovery is handled by the NAN Discovery Engine (e.g., as illustrated in FIG. 4) and is responsible for discovering devices (or services made available on devices) for specific services through publish and/or subscribe messages. Publish messages may advertise, or make discoverable, a service(s) offered by a NAN device and subscribe messages may advertise the will to engage with or request a publish message from a device that offers a service(s).

There are various ways to accomplish a publish/subscribe handshake. For example, a NAN device can initiate periodic publish messages to solicit a subscription or a follow-up to the service(s). Conversely, a NAN device can instead initiate by repeatedly (e.g., periodically) sending subscribe messages to search for another device offering specific services. In either case, to increase the likelihood of finding a matching publisher/subscriber, these messages may need to be sent repeatedly for an extended time. A proxy device may publish/subscribe on behalf of one or more other devices. This may provide certain benefits, including saving on channel congestion (e.g., in the case of multiple devices using one proxy) or allowing the origin devices to save power.

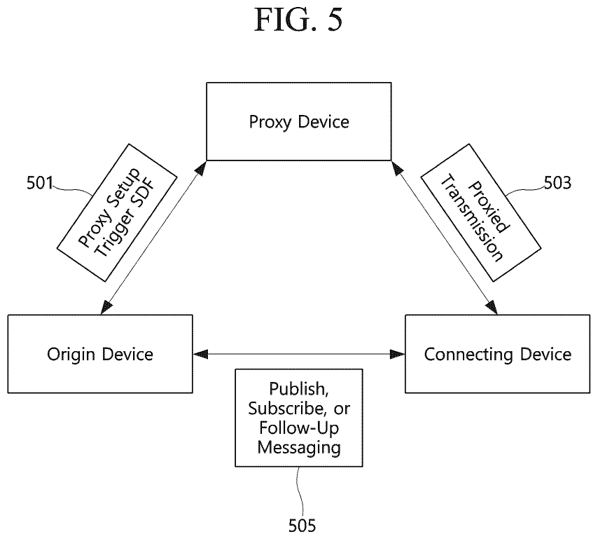

FIG. 5 illustrates an operation between two devices engaging in discovery through a proxy device in accordance with an embodiment. The devices may include an origin device, which may be a device that wants to transmit publish and/or subscribe messages through a proxy device. The proxy device may be a device that transmits publish and/or subscribe messages 505 on behalf of an origin device. The connecting device may be a device that wishes to subscribe to (or follow-up on) a service of an origin device or publish a service to an origin device. For example, an origin device on whose behalf the connecting device received a subscribe message 503 transmitted by a proxy device. As illustrated, the origin device may communicate, including transmitting a service discovery frame (SDF) 501, with the proxy device. The proxy device may transmit a proxied transmission 503, which may include transmitting an SDF that has been derived from the SDF received from the origin device, to the connecting device. Accordingly, the origin device may communicate 505 (e.g., publish, subscribe, or follow-up messaging) with the connecting device.

Embodiments in accordance with this disclosure may provide procedures where an origin device's transmission may trigger a proxy device to transmit proxied messaging. In some embodiments, after configuring the proxy device with one or more service IDs designated for proxied transmission, the origin device may provide an indication to the proxy device regarding when the proxy transmissions should begin. The origin device may also provide other information, in addition to the service IDs, that the proxy transmission should include. In some embodiments, the origin device may dynamically control when the proxy device may transmit the proxied attributes.

In some embodiments, an origin device's SDF may be used as a trigger for triggering the proxy device's SDF transmission. The proxy device's SDF may be derived from the origin device's SDF, and may include one or more service descriptor attributes (SDAs) and other attributes intended for proxied transmission. The SDA may provide information regarding services that a device wants to publish or subscribe to. In some embodiments, an SDA may include a service identifier that identifies a service provided by the origin device. The SDA may include a unique service identifier along with information indicating which function the SDA corresponds to (e.g., Publish, Subscribe, Follow-up, among others). The SDA may include one or more optional fields that provide more information regarding the use of a service by a receiving device.

In some embodiments, an origin device may configure the proxy device with one or more service IDs that are designated for proxied transmission. In some embodiments, the SDF may include the service IDs and other information of a service represented by these service IDs, that the origin device wants the proxy device to transmit on its behalf. In some embodiments, the origin device may transmit an SDF that includes one or more SDAs with designated service IDs. In some embodiments, the proxy device may detect the incoming SDF from the origin device, where the SDF includes on or more SDAs with designated service IDs. The proxy device may identify one or more attributes from the SDF, including a SDA attribute or a SDF attribute, to be proxy transmitted. The proxy device may transmit a SDF that may include attributes based on or related to the attributes received from the SDF provided by the origin device.

In some embodiments, the detection of the origin device's SDF may be used to indicate to the proxy device that proxy transmission should begin. The proxy device may use the origin device's SDF to derive its own SDF including the proxied attributes.

In some embodiments, the origin device may also include an indication in the transmitted SDF that indicates whether it wants the proxy device to do a proxied transmission based on the SDF being transmitted. In some embodiments, the proxy transmission indication may be carried in the SDA, and may be service ID specific. Moreover, in the SDA, this indication may be carried as a ‘proxy triggering’ matching filter <length, value> pair. For example, if the proxy trigger matching filter pair is set to <1,0xFF>, it may indicate to the proxy device to perform a proxied transmission based on the SDA from the origin device. Whereas, if it the matching filter pair is set to any other value, it may indicate to the proxy device to ignore the SDA from the origin device or not perform a proxied transmission based on the SDA from the origin device. In some embodiments, the proxy device may then proceed as dictated by the origin device through the indication included in the SDF.

In some embodiments, the origin device may use its own message as both the source material for the proxy device to derive the proxied message and as an indicator for the proxy device to begin transmitting proxy messages.

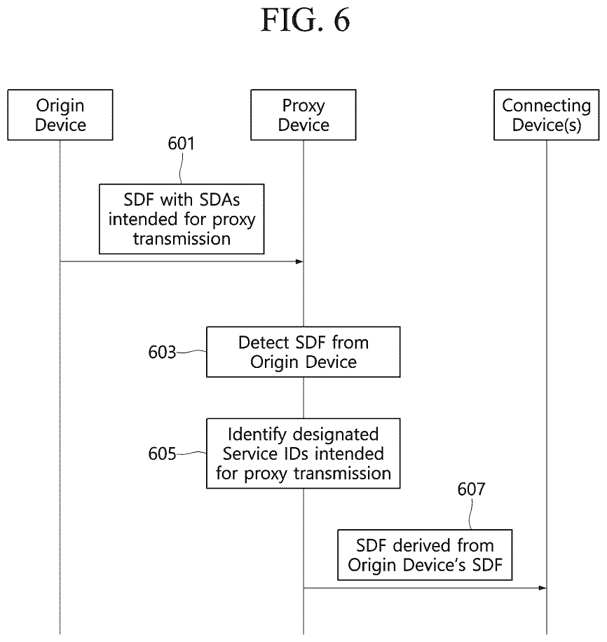

FIG. 6 illustrates communication between an origin device and a proxy device for proxy transmission in accordance with an embodiment. In some embodiments, the proxy device may be configured with one or more designated service IDs by the origin device. As illustrated, in operation 601, the origin device transmits to the proxy device an SDF with SDAs intended for proxy transmission. In some embodiments, the SDF may include one or more service identifiers (IDs) designated for proxied transmission. For example, these are the service IDs, and possibly further information of a service represented by these service IDs, that the origin device wants the proxy device to transmit on its behalf.

In operation 603, the proxy device detects an SDF from the origin device.

In operation 605, the proxy device identifies designated service IDs intended for proxy transmission. In some embodiments, the SDF may include an SDA with a designated service ID.

In operation 607, the proxy device begins a proxied transmission of an SDF derived from the origin device's SDF. In some embodiments, the detection of the origin device's SDF may be used to indicate to the proxy device that the proxy transmission should begin. In some embodiments, the proxy device may use the origin device's SDF to derive its own SDF that includes proxied attributes. The proxy device's SDF may be derived from the origin device's SDF, and may include one or more SDAs and other attributes intended for proxied transmission. In some embodiments, an SDA may include a service identifier that identifies a service provided by the origin device.

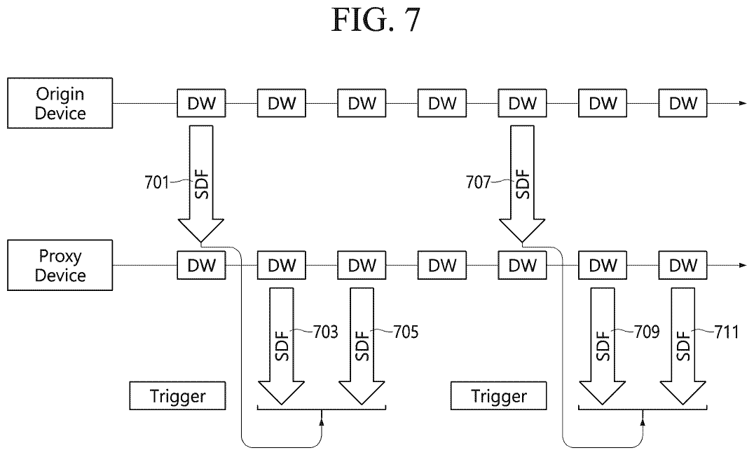

FIG. 7 illustrates a block diagram example depicting the origin device triggering proxy device's SDF transmission with its own SDF transmission during subsequent discovery windows (DWs) in accordance with an embodiment. In particular, the proxy device receives a first SDF 701 that includes an SDA with a designated service ID, from the origin device on one DW and may transmit proxied SDFs 703 and 705, based on the first received SDF, on two subsequent DWs. Then the proxy device receives a second SDF 707 that includes an SDA with the designated service ID, where this second SDF may include information that has been updated or changed compared to the information in the first SDF. The proxy device may subsequently transmit proxied SDFs 709 and 711, based on the second received SDF 707, on two subsequent DWs. As illustrated, since proxy device's transmission on behalf of origin device is triggered by and based on a recent direct transmission (publish or subscribe as the case may be) of the origin device, the origin device may not need to re-configure the proxy device with updated information in a dedicated or an extra transmission.

In some embodiments, the origin device may transmit the triggering SDF asynchronously/outside of a DW. In some embodiments, the origin device may transmit in a further availability window (FAW) of a proxy device. In some embodiments, an origin device may get blocked during DW due to high congestion, but may still transmit in FAW of proxy device and get the benefit of proxy transmission in the future.

In some embodiments, the proxy device may transmit proxied SDFs on a different band with different DW timings. For example, the origin device may transmit an SDF in the 2.4 GHZ band to trigger a proxy device SDF transmission in the 5 GHz band. A transmission in 2.4 GHZ band typically consumes slightly lower power than 5 GHz band. In some embodiments, the origin device may opportunistically determine which band to transmit in, e.g., based on where it can win contention based channel access first.

In some embodiments, the proxy device may wait for a certain time offset after the triggering SDF from the origin device before beginning to transmit proxied SDFs. For example, the origin device may transmit an SDF at DW0 to trigger the proxy device SDF transmission of proxied attributes at DWn.

In some embodiments, after transmitting an SDF which in turn triggers the proxy device to do a proxied transmission, the origin device may verify if the proxy device is functioning as expected. In particular, to determine if proxy device received the SDF transmitted by the origin device. In some embodiments, the origin device may listen for the proxied transmission during one or more occasions where the proxy device is expected or required to perform a proxied transmission. The origin device may use the detection of proxied transmission as an implicit ACK (acknowledgement) that the proxy device received the origin's SDF. Since it is possible that, even if proxy device received the origin's SDF, the proxy device may not get an opportunity to transmit proxied SDF due to channel congestion, therefore, the origin device may choose to listen during more than one proxied transmission occasion to decide. If the origin device determines that proxy device is not transmitting proxied SDF, it may retransmit the ‘triggering’ SDF.

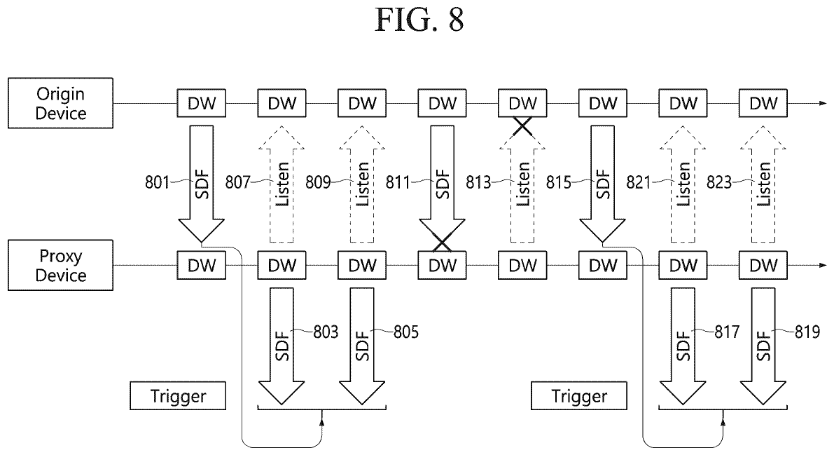

FIG. 8 illustrates an example depicting the origin device verifying proxy operation by listening for SDF transmissions from the proxy device. As illustrated, the origin device listens for expected SDF transmissions from the proxy device, including proxy transmission 803 and 805, which origin device listens and hears on 807 and 809. As illustrated, the origin device detects proper proxy operation after the first ‘triggering’ SDF 801 for the proxy session, but detects a missing proxy transmission in proxy session 813 and 815, instigating the origin device to retransmit an SDF 821. In particular, origin device transmits an SDF 811 to the proxy device, and listens on 813 but does not detect the corresponding proxy transmission of the SDF. Accordingly, origin device retransmits SDF 821, which proxy device transmits proxied transmissions 817 and 819, which origin device correspondingly hears on 821 and 823.

In some embodiments, the origin device transmits the SDF that is to be used to derive the proxied SDF separately from the indication to trigger the start of proxy transmission. In some embodiments, the SDF from the origin device that includes attributes intended for proxy transmission may be independent from the trigger used to initiate transmission of the proxied attributes.

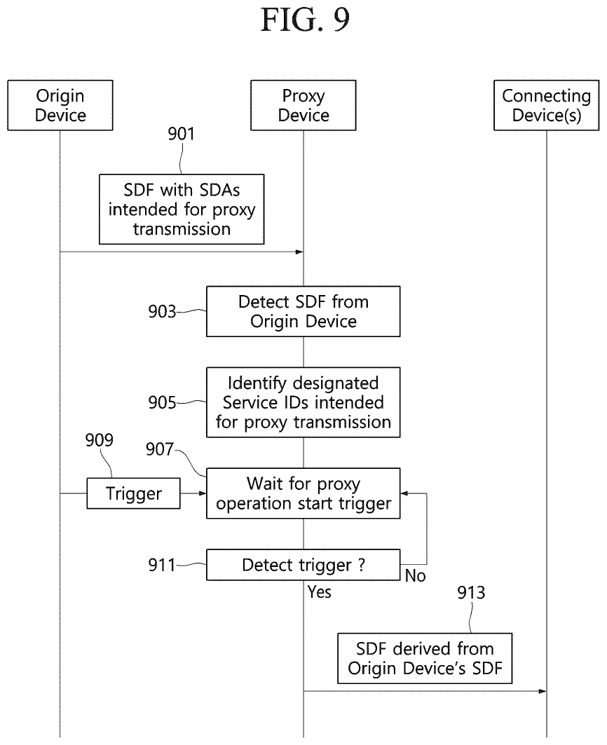

FIG. 9 illustrates communication between an origin device and a proxy device for triggered proxy transmission in accordance with an embodiment. In some embodiments, since the origin device's proxy triggering message is untethered from the SDF transmission that includes the proxied attributes, the trigger message can be sent completely asynchronously using a different radio access technology (RAT) entirely.

In operation 901, the origin device transmits to the proxy device an SDF with SDAs intended for proxy transmission.

In operation 903, the proxy device detects the SDF from the origin device.

In operation 905, the proxy device identifies designed service IDs intended for proxy transmission. In some embodiments, the SDF may include an SDA with a designated service ID.

In operations 907 and 911, the proxy device waits for a proxy operation start trigger from the origin device and determines whether it has received a trigger frame from the origin device.

If in operation 911, the proxy device determines that it has not received a trigger, the proxy device returns to 907 and continues waiting.

In operation 909, the origin device transmits to the proxy device a trigger frame.

In operation 911, the proxy device determines that it has received the trigger frame from the origin device and proceeds to operation 913.

In operation 913, the proxy device begins a proxied transmission (e.g., publish or subscribe messages) of an SDF derived from the origin device's SDF. In some embodiments, the proxy device may use the origin device's SDF to derive its own SDF that includes proxied attributes. The proxy device's SDF may be derived from the origin device's SDF, and may include one or more SDAs and other attributes intended for proxied transmission. In some embodiments, an SDA may include a service identifier that identifies a service provided by the origin device.

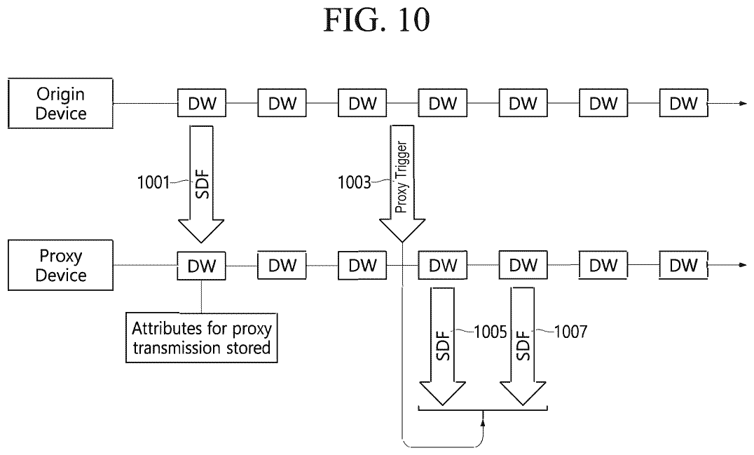

FIG. 10 illustrates an example depicting the origin device first transmitting an SDF that includes attributes to be sent via proxy followed by another message sent asynchronously, triggering proxy device's SDF transmission during subsequent discovery windows (DWs). In particular, FIG. 10 illustrates an example scenario in which the origin device first transmits an SDF 1001 that includes attributes for proxy transmission, followed by a proxy trigger message 1003. As illustrated, the proxy message may be sent asynchronously (outside of a discovery window or further availability window). Some embodiments may use Bluetooth and/or other radio access technologies. Once the proxy device receives the trigger message, it may begin transmitting SDFs, including SDF 1005 and 1007, that include the proxied attributes.

Embodiments in accordance with this disclosure can provide a proxy device that can transmit publish and/or subscribe messages on behalf of one or more other origin devices, which may improve channel congestion whereby multiple devices may use a single proxy to transmit messages. Benefits may also include allowing origin devices to save power by using the resources of a proxy device to periodically transmit messages on behalf of the origin device.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term “include,” “have,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

As described herein, any electronic device and/or portion thereof according to any example embodiment may include, be included in, and/or be implemented by one or more processors and/or a combination of processors. A processor is circuitry performing processing.

Processors can include processing circuitry, the processing circuitry may more particularly include, but is not limited to, a Central Processing Unit (CPU), an MPU, a System on Chip (SoC), an Integrated Circuit (IC) an Arithmetic Logic Unit (ALU), a Graphics Processing Unit (GPU), an Application Processor (AP), a Digital Signal Processor (DSP), a microcomputer, a Field Programmable Gate Array (FPGA) and programmable logic unit, a microprocessor, an Application Specific Integrated Circuit (ASIC), a neural Network Processing Unit (NPU), an Electronic Control Unit (ECU), an Image Signal Processor (ISP), and the like. In some example embodiments, the processing circuitry may include: a non-transitory computer readable storage device (e.g., memory) storing a program of instructions, such as a DRAM device; and a processor (e.g., a CPU) configured to execute a program of instructions to implement functions and/or methods performed by all or some of any apparatus, system, module, unit, controller, circuit, architecture, and/or portions thereof according to any example embodiment and/or any portion of any example embodiment. Instructions can be stored in a memory and/or divided among multiple memories.

Different processors can perform different functions and/or portions of functions. For example, a processor 1 can perform functions A and B and a processor 2 can perform a function C, or a processor 1 can perform part of a function A while a processor 2 can perform a remainder of function A, and perform functions B and C. Different processors can be dynamically configured to perform different processes. For example, at a first time, a processor 1 can perform a function A and at a second time, a processor 2 can perform the function A. Processors can be located on different processing circuitry (e.g., client-side processors and server-side processors, device-side processors and cloud-computing processors, among others).

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A station (STA) in a wireless network, the STA comprising:
a memory; and
a processor coupled to the memory, the processor configured to:
receive, from an origin STA, a first discovery frame that includes one or more services intended for proxy transmission and one or more service identifiers each associated with a respective one of the one or more services;
identify the one or more services based on the one or more service identifiers;
generate a second discovery frame based on the first discovery frame, wherein the second discovery frame includes the one or more services intended for proxy transmission included in the first discovery frame; and
transmit, to one or more other STAs on behalf of the origin STA, the second discovery frame.

2. The STA of claim 1, wherein the one or more services include a publish service that is a service that the origin STA offers to the one or more other STAs or a subscribe service that is a service that the origin STA seeks from the one or more other STAs.

3. The STA of claim 1, wherein the first discovery frame solicits that the STA transmits the second discovery frame.

4. The STA of claim 1, wherein the processor is further configured to:
receive a trigger frame soliciting that the STA transmits the second discovery frame; and
transmit, to the one or more other STAs, the second discovery frame in response to the trigger frame.

5. The STA of claim 1, wherein the processor is further configured to transmit the second discovery frame after a time offset after receiving the first discovery frame from the origin STA.

6. The STA of claim 1, wherein the processor is further configured to:
receive, from the origin STA, a third discovery frame that includes updated one or more services intended for proxy transmission and updated one or more service identifiers each associated with a respective one of the one or more services;
generate a fourth discovery frame based on the third discovery frame, wherein the fourth discovery frame includes the updated one or more services intended for proxy transmission included in the third discovery frame; and
transmit, to the one or more other STAs, the fourth discovery frame.

7. The STA of claim 1, wherein the first discovery frame is received during a discovery window.

8. The STA of claim 1, wherein the first discovery frame is received in a first frequency band and the second discovery frame is transmitted on a second frequency band.

9. A station (STA) in a wireless network, the STA comprising:
a memory; and
a processor coupled to the memory, the processor configured to:
transmit, to a proxy STA, a first discovery frame that includes the one or more services intended for proxy transmission and one or more service identifiers each associated with a respective one of the one or more services;
listen for a transmission to one or more other STAs of a second discovery frame derived from the first discovery frame during one or more expected discovery windows during which the proxy STA is expected to perform proxied transmission of the second discovery frame.

10. The STA of claim 9, wherein the processor is further configured to:
determine that the proxy STA is not transmitting the second discovery frame for a predetermined time; and
retransmit the first discovery frame to the proxy STA.

11. The STA of claim 9, wherein the processor is further configure to:
transmit, to the proxy STA, a trigger frame that solicits that the proxy STA transmits the second discovery frame.

12. The STA of claim 9, wherein the first discovery frame is transmitted during a discovery window.

13. The STA of claim 9, wherein the first discovery frame is transmitted in a first frequency band and the second discovery frame is transmitted on a second frequency band.

14. A computer-implemented method for wireless communication by a station (STA) in a wireless network, comprising:
receiving, from an origin STA, a first discovery frame that includes one or more services intended for proxy transmission and one or more service identifiers each associated with a respective one of the one or more services;
identifying the one or more services based on the one or more service identifiers;
generating a second discovery frame based on the first discovery frame, wherein the second discovery frame includes the one or more services intended for proxy transmission included in the first discovery frame; and
transmitting, to one or more other STAs on behalf of the origin STA, the second discovery frame.

15. The computer-implemented method of claim 14, wherein the one or more services include a publish service that is a service that the origin STA offers to the one or more other STAs or a subscribe service that is a service that the origin STA seeks from the one or more other STAs.

16. The computer-implemented method of claim 14, wherein the first discovery frame solicits that the STA transmits the second discovery frame.

17. The computer-implemented method of claim 14, further comprising:
receiving a trigger frame soliciting that the STA transmits the second discovery frame; and
transmitting, to the one or more other STAs, the second discovery frame in response to the trigger frame.

18. The computer-implemented method of claim 14, wherein the second discovery frame is transmitted after a time offset after receiving the first discovery frame from the origin STA.

19. The computer-implemented method of claim 14, further comprising:
receiving, from the origin STA, a third discovery frame that includes updated one or more services intended for proxy transmission and updated one or more service identifiers each associated with a respective one of the one or more services;
generating a fourth discovery frame based on the third discovery frame that includes the updated one or more services intended for proxy transmission included in the third discovery frame; and
transmitting, to the one or more other STAs, the fourth discovery frame.

20. The computer-implemented method of claim 14, wherein the first discovery frame is received during a discovery window.
